(19) United States
(12) Patent Application Publication
(10) Pub. No.: US 2016/0323092 A1
(43) Pub. Date: Nov. 3, 2016

(54) TRANSFER APPARATUS

(71) Applicant: FUJITSU LIMITED, Kawasaki-shi (JP)

(72) Inventors: Sadayoshi HANDA, Neyagawa (JP); Takanori Yasui, lkoma (JP); Hirofumi Fujiyama, Sakai (JP); Hiroshi KUNITAKE, Suita (JP); Mitsuhiro KAWAGUCHI, Nara (JP)

(73) Assignee: FUJITSU LIMITED, Kawasaki-shi (JP)

(21) Appl. No.: 15/074,251

(22) Filed: Mar. 18, 2016

(30) Foreign Application Priority Data
Apr. 28, 2015 (JP) 2015-092212

(51) Int. Cl. H04L 7/00

(52) U.S. Cl. CPC H04L 7/0016

(57) ABSTRACT

A transfer apparatus comprising a first switch configured to generate a first timing pulse based on a reference clock, transmit first information related to the first timing pulse, a second switch configured to, generate a second timing pulse based on the reference clock, transmit second information related to the second timing pulse, a line interface configured to receive signal data and store the signal data in a memory, transfer the signal data based on the first timing pulse when the first information is received, and transfer the signal data based on the information when the first information is not received and the second information is received, detect a phase shift between the first timing pulse and the second timing pulse, transmit the phase shift to the second switch, wherein the second switch is configured to correct, based on the phase shift, a timing that the second timing pulse is generated.

### CROSS-REFERENCE TO RELATED APPLICATION

This application is based upon and claims the benefit of priority of the prior Japanese Patent Application No. 2015-092212, filed on Apr. 28, 2015, the entire contents of which are incorporated herein by reference.

### FIELD

The embodiment discussed herein relates to a transfer apparatus.

### BACKGROUND

Conventional transfer devices using SONET/SDH or OTN have a SWF unit that achieves a redundant configuration due to an active system (work) and a standby system (protect) in order to avoid service interruptions due to an obstacle. When an active system SWF unit is damaged or removed and the SWF unit is switched to the standby system SWF unit, a phase shift in the timing pulse may occur. The phase shift in the timing pulse is absorbed by using a FIFO inside the LIU.

Japanese Laid-open Patent Publication No. 05-268197 and Japanese Laid-open Patent Publication No. 2004-146984, for example, discuss techniques for correcting a phase shift by delaying the advance unit and resetting a counter when a phase shift is present, for example, in order to change a frame pulse phase and reduce the phase difference with another frame pulse.

### SUMMARY

According to an aspect of the invention, a transfer apparatus comprising a memory, a first switch configured to generate a first timing pulse based on a reference clock, transmit first information related to the first timing pulse, a second switch configured to, generate a second timing pulse based on the reference clock, transmit second information related to the second timing pulse, a line interface configured to receive signal data and store the signal data in the memory, transfer the signal data stored in the memory based on the first timing pulse when the first information is received, and transfer the signal data based on the information when the first information is not received and the second information is received, detect a phase shift between the first timing pulse and the second timing pulse based on the first information and the second information, transmit the detected phase shift to the second switch, wherein the second switch is further configured to correct, based on the phase shift, a timing that the second timing pulse is generated.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a network configuration including a transfer device according to the embodiment;

FIG. 2A is a view for explaining an example (1 of 3) of a shelf configuration of the transfer device according to the embodiment;

FIG. 2B is a view for explaining an example (2 of 3) of a shelf configuration of the transfer device according to the embodiment;

FIG. 2C is a view for explaining an example (3 of 3) of a shelf configuration of the transfer device according to the embodiment;

FIG. 3 is a block diagram of an example of a configuration of the transfer device according to the embodiment;

FIG. 4 is a timing chart illustrating the relationships between an in-device reference clock, a system clock (SYSCLK) in a SWF unit, and a timing pulse (TP);

FIG. 5 is view for explaining an example of a FIFO configuration;

FIG. 6 is a view for explaining an example of the contents of a FIFO monitoring counter; and

FIG. 7 is a flow chart of an example of operating procedures of the transfer device according to the embodiment.

### DESCRIPTION OF EMBODIMENT

When switching between an active system SWF unit and a standby system SWF unit is repeated during continuous operations of a transfer device, the problem of the main signal becoming an error may arise when the phase shift exceeds a tolerable range that can be absorbed with the FIFO inside the LIU. Moreover, there is a problem that the circuit of the FIFO inside the LIU may be increased in size in order to avoid the above problem.

In one aspect, an object of the embodiment discussed herein is to suppress the occurrence of transmission errors of main signals even when switching between the active system SWF unit and the standby system SWF unit is repeated.

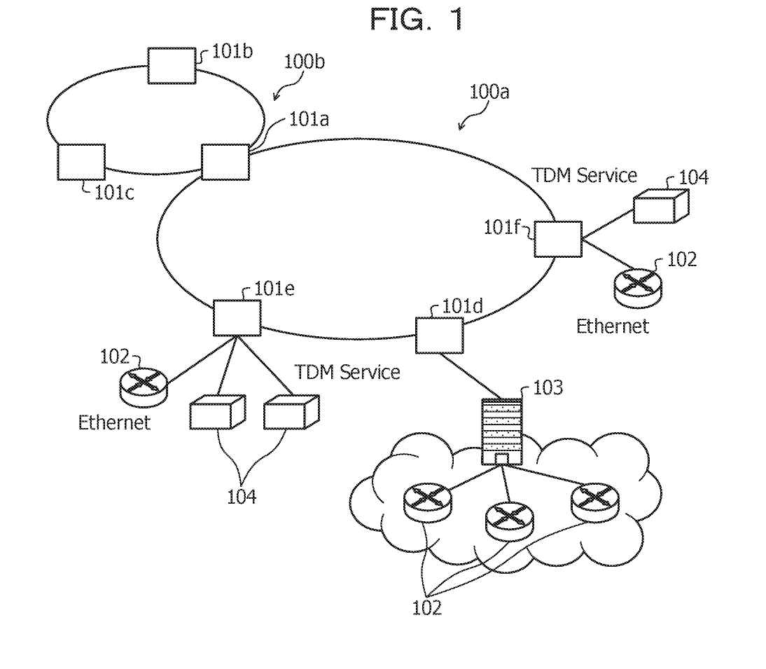

FIG. 1 illustrates an example of a network configuration including a transfer device 101 according to the embodiment. In FIG. 1, a wavelength Division Multiplexing (WDM)/add drop multiplexing (ADM) ring is provided with, for example, a plurality of transfer devices 101 (101a to 101f) that use a synchronous optical network/synchronous digital hierarchy (SONET/SDH) or an optical transport network (OTN).

Specifically, the transfer device 101a is provided between a WDM/ADM ring 100a and another WDM/ADM ring 100b and governs the transfer of main signal data between both WDM/ADM rings 100a and 100b. A plurality of transfer devices (transfer devices 101b, 101c) are provided in the WDM/ADM ring 100b and govern the transfer of main signal data with other networks which are omitted from the drawing.

Moreover, the transfer device 101d is connected to the WDM/ADM ring 100a and an in-house LAN 103 connected to a plurality of Ethernets (registered trademark) 102, and governs the transfer of the main signal data between the WDM/ADM ring 100a and the in-house LAN 103. The transfer devices 101e and 101f are connected to the WDM/ADM ring 100a, a plurality of Ethernets 102, and a time division multiplexing (TDM) service 104, and govern the transfer of main signal data therebetween.

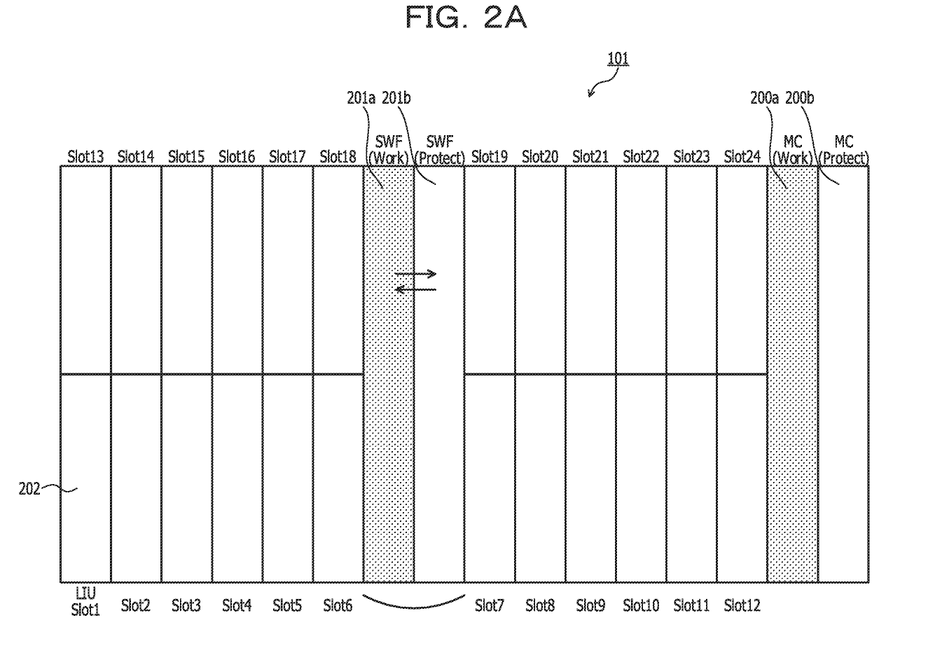

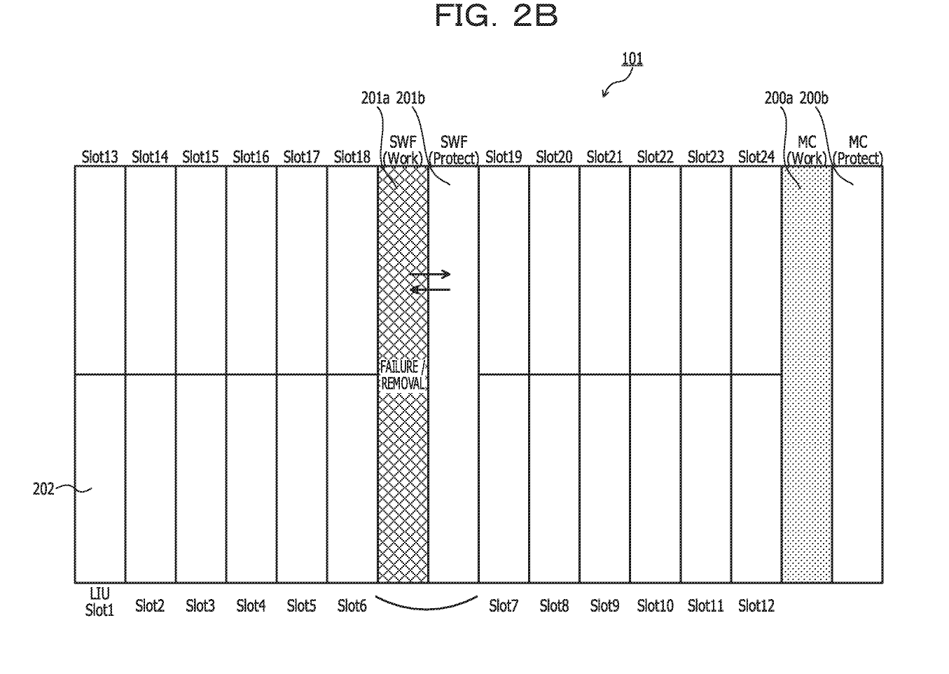

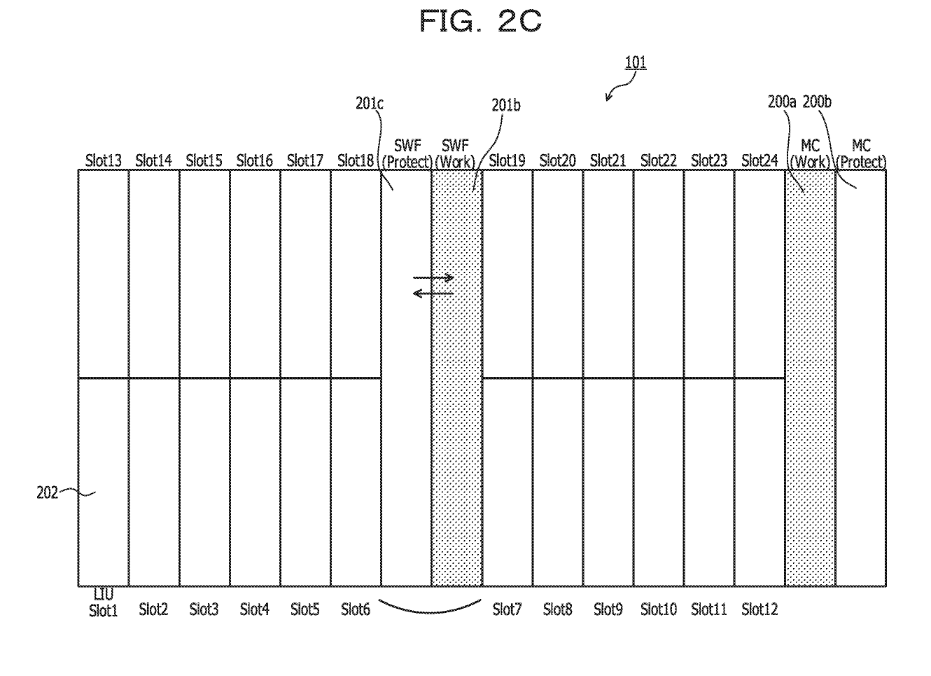

FIGS. 2A to 2C are views for explaining examples of a shelf configuration of a transfer device according to the embodiment. As illustrated in FIG. 2A, the transfer device 101 that uses SONET/SDH or OTN, for example, is provided with a main control unit (MC unit) 200, a switch unit (switch fabric (SWF) unit) 201, and a line interface unit (LIU) 202.

The MC unit 200 is made redundant through a MC (work: active system) unit 200a and a MC (protect) unit 200b. Therefore, when the active system MC (work) unit 200a is operating normally and then a failure (e.g., a failure such as an operation abnormality) or a removal (e.g., when the unit is removed due to a faulty unit) occurs in the operating MC (work) unit 200a, the MC unit 200 switches the operation to the standby system MC (protect) unit 200b and consequently the MC (protect) unit 200b operates normally as the active system MC (work) unit. Then a newly provided MC unit (not illustrated) becomes the standby system MC (protect) unit in place of the MC (work) unit 200a that had been operating up until that point.

The SWF unit 201 is also made redundant in the same way as the MC unit 200 through a SWF (work) unit 201a and a SWF (protect: standby system) unit 201b.

Therefore as illustrated in FIG. 2B, when the SWF (work) unit 201a is operating normally and then a failure or a removal occurs in the operating SWF (work) unit 201a, the operation of the SWF unit 201 is also switched to the standby system SWF (protect) unit 201b and consequently the standby system SWF (protect) unit 201b becomes the active system SWF (work) unit. As illustrated in FIG. 2C, a newly provided SWF unit 201c becomes the standby system SWF (protect) unit in place of the SWF (work) unit 201a that had been operating up until that point.

The LIU 202 is configured by a plurality of units provided in a plurality of slots from slot 1 to slot 24. The LIUs 202 are not made redundant. Therefore, when any of the LIUs 202 have a failure or are removed, the LIUs are controlled so that any of the LIUs provided in another slot can be used as a replacement until a new LIU is provided.

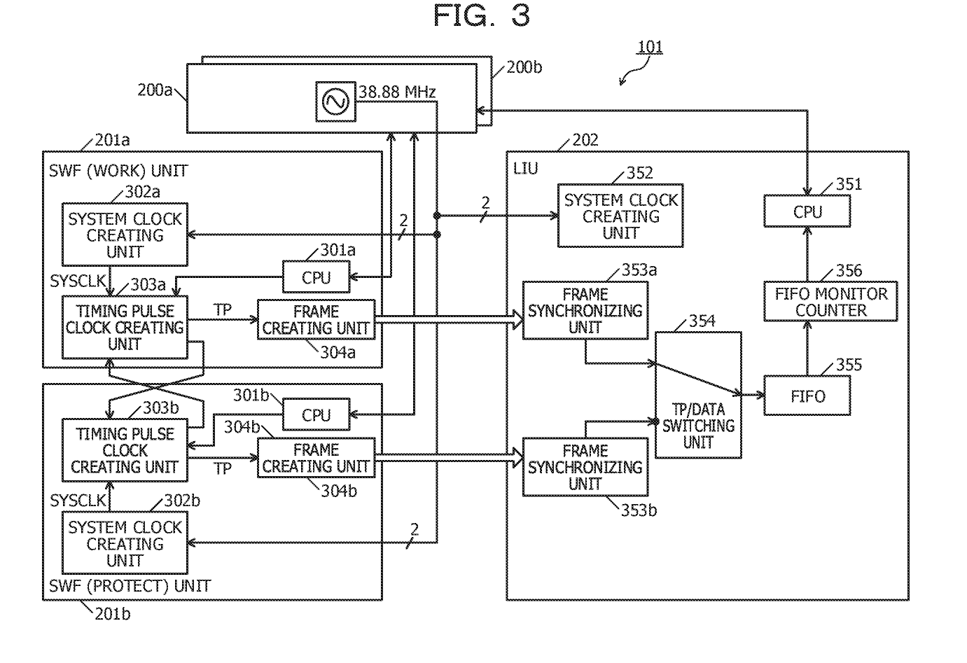

FIG. 3 is a block diagram of an example of a configuration of the transfer device according to the embodiment. In FIG. 3, the transfer device 101 is configured by the redundant MC units 200 (200a, 200b), the redundant SWF (work) unit 201a and the SWF (protect) unit 201b, and a previously selected LIU (monitoring LIU) 202. Other LIUs besides the monitoring LIU are omitted from the drawing.

The MC units 200 (200a, 200b) are shared control units for controlling each of the units in the transfer device 101. The MC units 200 generate an in-device reference clock (e.g., a clock having a frequency of “38.88 MHz”) and distribute the in-device reference clock to the SWF (work) unit 201a, the SWF (protect) unit 201b, and the LIU 202. The MC units 200 are redundant and therefore generate the in-device reference clocks for both the MC units 200a and 200b and distribute the respective in-device reference clocks to the SWF (work) unit 201a, the SWF (protect) unit 201b, and the LIU 202. However, only the in-device reference clock from the MC unit 200a that is operating is used as the in-device reference clocks in the SWF (work) unit 201a, the SWF (protect) unit 201b, and the LIU 202.

The SWF units 201 (SWF (work) unit 201a, SWF (protect) unit 201b) are each provided with a CPU 301 (310a, 301b), a system clock creating unit 302 (302a, 302b), a timing pulse clock creating unit 303 (303a, 303b), and a frame creating unit 304 (304a, 304b).

The LIU 202 is provided with a CPU 351, a system clock creating unit 352, two frame synchronizing units 353a and 353b, a TP/data (main signal data) switching unit 354, a first-in first-out (FIFO) 355, and a FIFO monitor counter 356.

### (SWF Unit 201 Configuration)

Each CPU 301 (301a, 301b) in the SWF units 201 (SWF (work) unit 201a, SWF (protect) unit 201b) governs the control of the entire SWF unit 201. The CPUs 301 are connected to the MC unit 200a (via an interface that is omitted from the drawing) and receive commands from the MC unit 200a and execute the commands. The CPUs 301 output various types of information pertaining to the SWF unit 201 to the MC unit 200a. The contents of the commands to be executed and the specific contents of the various types of information to be outputted are described below.

The system clock creating units 302 (302a, 302b) each generate a system clock (SYSCLK) inside the SWF units 201 so as to be synchronized with the in-device reference clock based on the in-device reference clock distributed from the MC unit 200a.

The timing pulse clock creating units 303 (303a, 303b) generate timing pulses (TP) according to the SYSCLK generated by the system clock creating units 302. The frame creating units 304 (304a, 304b) use the timing pulses generated by the timing pulse clock creating units 303 to generate main signal frames.

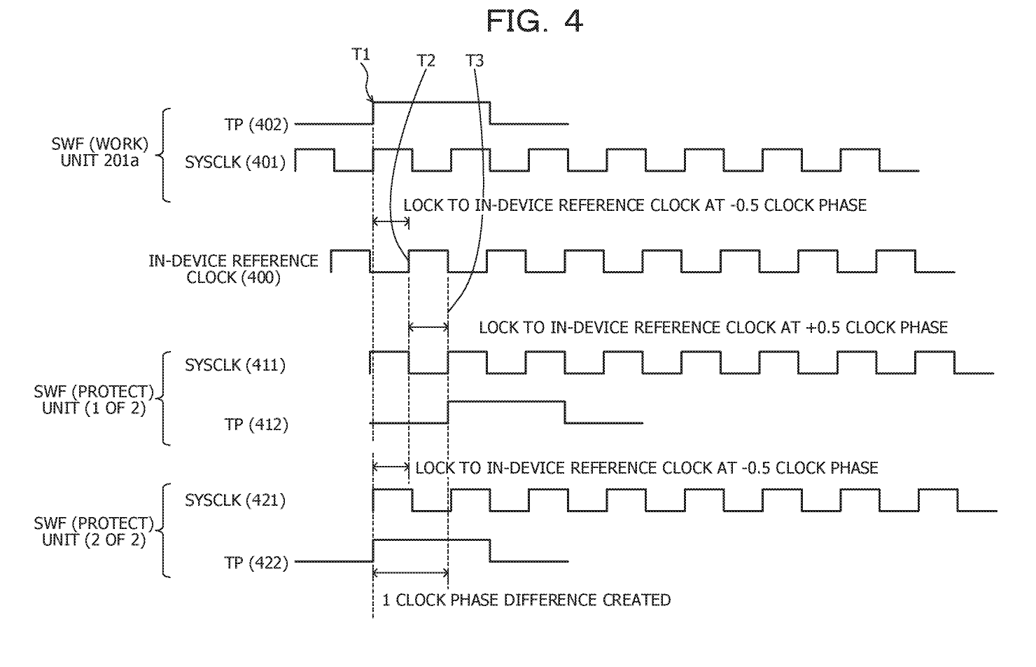

FIG. 4 is a timing chart illustrating the relationships between the in-device reference clock, the system clocks (SYSCLK) in the SWF units 201 (201a, 201b), and the timing pulses (TP). In FIG. 4, the system clock creating unit 302a in the SWF (work) unit 201a generates a SYSCLK 401 so as to be synchronized with an in-device reference clock 400. As illustrated in FIG. 4, the SYSCLK 401 is generated by locking to a predetermined timing (“T2”) of the in-device reference clock 400 with a −0.5 clock phase (timing “T1”). A TP 402 is then generated at the timing “T1” of the generated SYSCLK 401.

Meanwhile, a SYSCLK 411 generated by the system clock creating unit 302b in the SWF (protect) unit 201b (1 of 2) is generated by locking to a predetermined timing (“T2”) of the in-device reference clock 400 with a +0.5 clock phase (timing “T3”) as illustrated in FIG. 4. A TP 412 is then generated at the timing “T3” of the generated SYSCLK 411 in accordance with the SYSCLK 401 of the SWF (work) unit 201a.

The generated timing of the TPs in the SWF (protect) unit 201b differ due to the locked timing even in the same SWF (protect) unit 201b. That is, a SYSCLK 421 generated by the system clock creating unit 302b in the SWF (protect) unit 201b (2 of 2) is generated by locking to the predetermined timing (“T2”) of the in-device reference clock 400 with a −0.5 clock phase (“T1” timing) in the same way as the SWF (work) unit 201a as illustrated in FIG. 4. A TP 422 is then generated at the timing “T1” of the generated SYSCLK 421 in accordance with the TP 402 of the SWF (work) unit 201a.

In this way, even when the TP generated by the SWF (protect) unit 201b is generated in accordance with the TP generated by the SWF (work) unit 201a, the maximum phase difference that is generated is one clock according to which timing of the in-device reference clock 400 the SYSCLKs are locked. This phase shift may be generated each time a SWF unit is switched.

### (LIU 202 Configuration)

The CPU 351 in the LIU 202 depicted in FIG. 3 governs the control of the entire LIU 202 unit. The CPU 351 is connected to the MC unit 200a (via an interface that is omitted from the drawing) and receives commands from the MC unit 200a and executes the commands. The CPU 351 output various types of information pertaining to the LIU 202 to the MC unit 200a.

The system clock creating unit 352 generates a system clock (SYSCLK) inside the LIU 202 based on the in-device reference clock distributed from the MC unit 200a.

The frame synchronizing unit 353a performs synchronizing processing on the received main signal data using the main signal frame generated by the frame creating unit 304a in the SWF (work) unit 201a, and transmits the main signal data to the TP/data switching unit 354. Similarly, the frame synchronizing unit 353b performs synchronizing processing on the received main signal data using the main signal frame generated by the frame creating unit 304b in the SWF (protect) unit 201b, and transmits the main signal data to the TP/data switching unit 354.

The TP/data switching unit 354 inputs the main signal data transmitted from the frame synchronizing unit 353a and the main signal data transmitted from the frame synchronizing unit 353b and outputs either one of the main signal data to the FIFO 355. Switching processing is performed according to a command from the CPU 351. Alternatively, the switching processing may be performed according to a predetermined condition (e.g., when data from the frame synchronizing unit in the switched unit is not allowed to be received, etc.).

The FIFO 355 writes the main signal data from the switched side and reads out the written main signal data in the order of writing. A write ADR counter and a read ADR counter are loaded at the timing of the TP 402 during initial activation. The reading starting timing (READ CRT 0) of the read ADR counter is fixed. Therefore, the starting timing of the reading is typically the same even if the writing timing is different. In this way, a phase shift of the timing pulse can be absorbed.

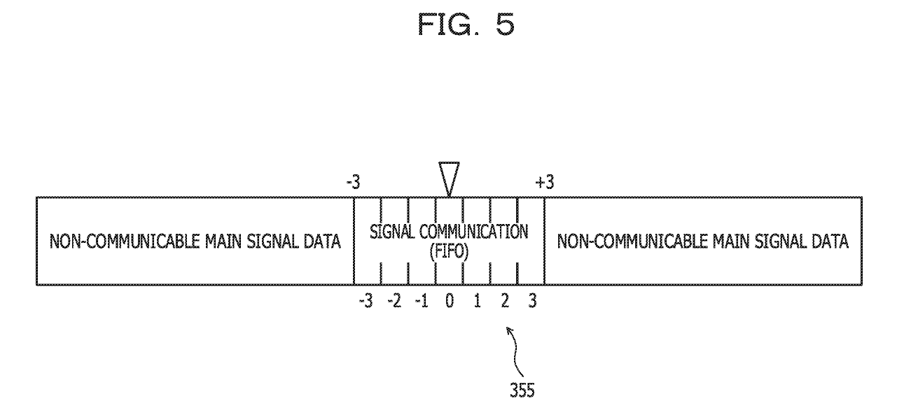

FIG. 5 is a view for explaining an example of a configuration of the FIFO 355. The FIFO 355 in FIG. 5 has a main signal data communication portion that is configured from three plus stages and three minus stages for a total of six stages. If the correction of the TP is performed accurately each time a SWF unit switching occurs, theoretically a phase shift greater than two clock portions would not be generated and thus one plus stage and one minus stage for a total of two stages would be sufficient. The FIFO 355 depicted in FIG. 5 has a total of six stages in order to more reliably ensure continuous operations. Therefore, the number of stages of the FIFO is not limited to the total of six stages. The FIFO may have four stages or may have more than six stages. Because both cases of the TP timing becoming quicker or slower are assumed, the write ADR counter is preferably set in the center of the FIFO 355.

The FIFO monitor counter 356 detects a phase shift of the received timing received from the SWF (work) unit 201a of the TP 402 during initial activation, that is, the received timing of the TP after switching with respect to the write ADR counter of the FIFO 355. The received timing from the SWF (work) unit 201a of the TP 402 during initial activation, that is, the write ADR counter of the FIFO 355, becomes the standard when later detecting the received timing of the TP after switching. Each time a switch occurs, the phase shift of the received timing of the TP after the switch is typically detected based on the standard. The standard is not changed until the transfer device is reactivated.

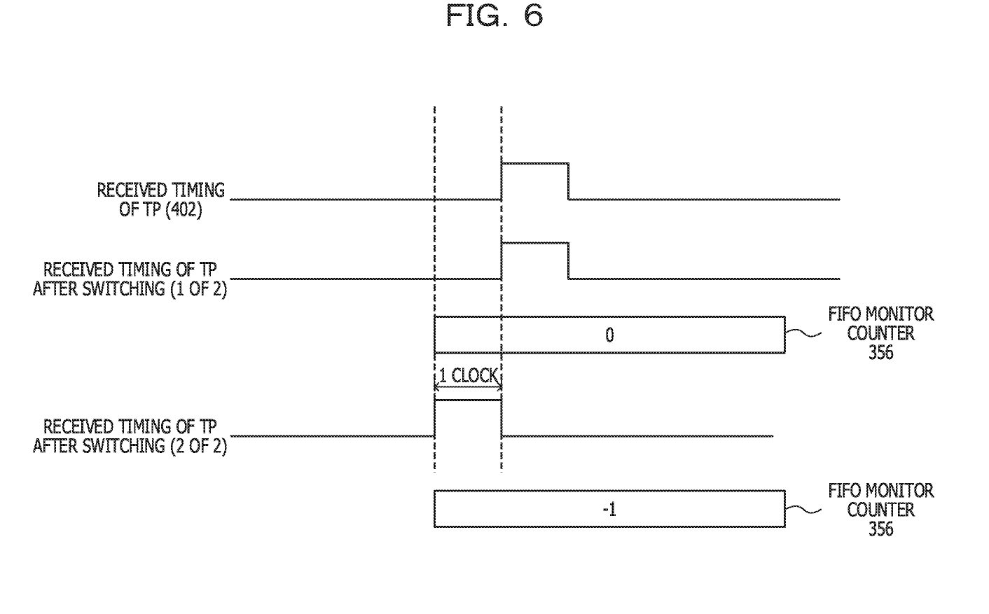

FIG. 6 is a view for explaining an example of the contents of the FIFO monitor counter 356. In FIG. 6, the phase shift of the received timing (1 of 2) of the TP after switching with respect to the received timing of the TP 402 during initial activation is smaller than one clock and thus the counter value of the FIFO monitor counter 356 is “0”. The phase shift of the received timing (2 of 2) of the TP after switching with respect to the received timing of the TP 402 during initial activation is one clock (one clock portion forward) and thus the counter value of the FIFO monitor counter 356 is “−1”. The counter value is not limited to “−1” and may be “−2” and the like.

Although not illustrated in FIG. 6, when the phase shift of the received timing of the TP after switching with respect to the received timing of the TP 402 during initial activation is one clock (one clock portion backward), the counter value of the FIFO monitor counter 356 is “+1”. The counter value is not limited to “+1” and may be “+2” and the like.

The detected counter values “0”, “−1”, and “+1” are transmitted to the CPU 351 and outputted from the CPU 351 to the MC unit 200a. The MC unit 200a receives the counter values and outputs, to the CPU 301b in the SWF (protect) unit 201b, a correction command for correcting the generated timing of the timing pulse generated by the timing pulse clock creating unit 303b, along with the counter value, that is, the phase shift amount. The timing pulse clock creating unit 303b corrects the generated timing of the timing pulse in accordance with the control of the CPU 301b.

Specifically, no correction occurs when the counter value is “0”. When the counter value is “−1”, the phase is corrected to become plus 1, that is, the phase is delayed by one clock portion so that the phase amount becomes “0”. Conversely, when the counter value is “+1”, the phase is corrected to become minus 1, that is, the phase is advanced by one clock portion so that the phase amount becomes “0”.

### (Operating Procedures of Transfer Device)

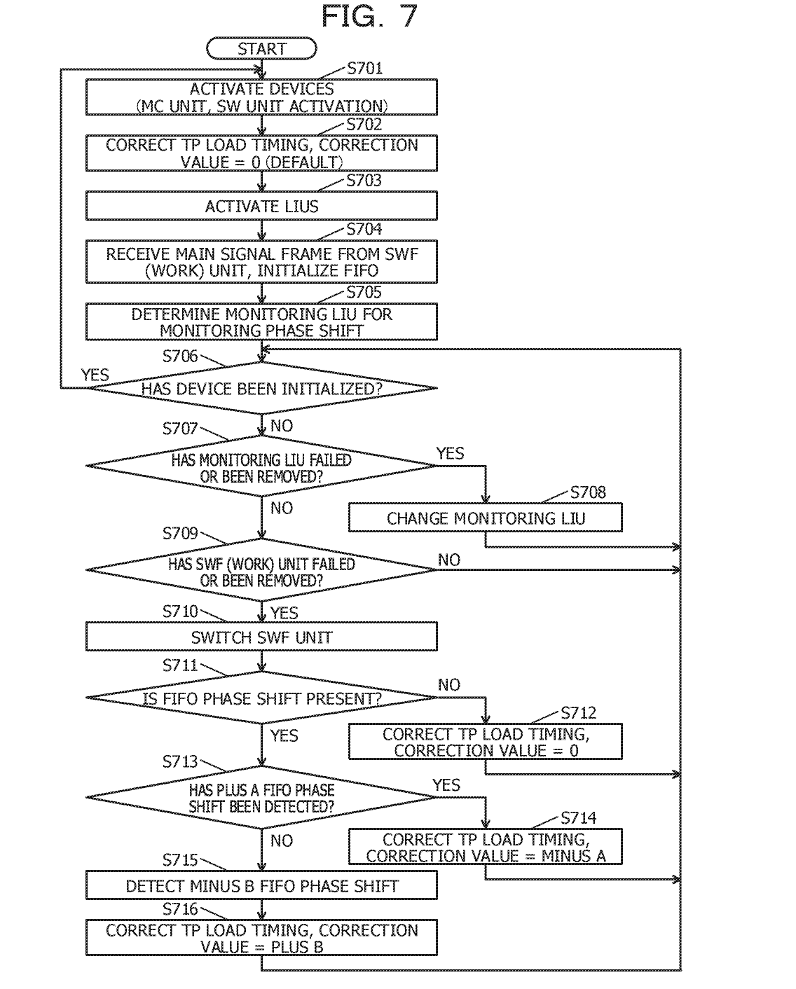

FIG. 7 is a flow chart of an example of operating procedures of the transfer device according to the embodiment. In the flow chart in FIG. 7, the transfer device is first activated (step S701). Specifically, the MC units 200 (200a, 200b) and the SWF units 201 (201a, 201b) are each activated (step S701).

The activated SWF (protect) unit 201b corrects the load timing of the TP generated in accordance with the TP (“standard TP”) received from the SWF (work) unit 201a side based on the in-device reference clock, so that the load timing becomes the correction value=0 (default) (step S702).

Next, all of the LIUs (slots 1-24) are mounted and activated (step S703). After activating the LIUs, the initialization of the FIFOs inside the LIUs is implemented at the point in time of the main signal frame reception from the SWF (work) unit 201a (step S704). Then, the monitoring LIU 202 for monitoring the phase shift is determined from the activated LIUs (step S705).

Next, a determination is made as to whether the transfer device has been initialized (step S706). If the transfer device has been initialized (step S706: Yes), the process returns to step S701 and the series of processes is repeated from the beginning. Conversely, if the transfer device has not been initialized (step S706: No), a determination is made as to whether the monitoring LIU 202 determined in step S705 has failed or has been removed (step S707). If the monitoring LIU 202 has failed or has been removed (step S707: Yes), the monitoring LIU 202 is changed to another LIU (step S708) and the process returns to step S706.

If the monitoring LIU 202 has not failed or been removed in step S707 (step S707: No), a determination is then made as to whether the SWF (work) unit 201a has failed or been removed (step S709). If the SWF (work) unit 201a has not failed or been removed (step S709: No), normal operation is being performed at that time and the process returns to step S706. Conversely, if the SWF (work) unit 201a has failed or has been removed (step S709: Yes), the TP/data switching unit 354 switches the SWF unit from the SWF (work) unit 201a to the SWF (protect) unit 201b (step S710).

Thereafter, the FIFO monitor counter 356 is confirmed and a determination is made as to whether there is a FIFO phase shift (step S711). If there is no FIFO phase shift (step S711: No), the generated TP of the switched SWF (protect→work) unit 201b is corrected so that the load timing thereof becomes the corrected value=0, that is, the correction is not performed (step S712). The process then returns to step S706.

However, if there is a FIFO phase shift in step S711 (step S711: Yes), a determination is made as to whether the FIFO phase shift is detected as plus A (where “A” is the counter value of the FIFO monitor counter 356) (step S713). If the FIFO phase shift is detected as plus A (step S713: Yes), the switched SWF (work→protect) unit 201a corrects the TP generated from the timing of the operating SWF (protect→work) unit 201b so that the load timing thereof becomes the correction value=minus A (step S714), and then the process returns to step S706.

Conversely, if the plus A of the FIFO phase shaft is not detected in step S713 (step S713: No), the FIFO phase shaft is detected as minus B (where “B” is the counter value of the FIFO monitor counter 356) (step S715). The switched SWF (work→protect) unit 201a then corrects the TP generated from the timing of the operational SWF (protect→work) unit 201b so that the load timing thereof becomes the correction value=plus B (step S716), and then the process returns to step S706.

When returning to step S706 after the SWF unit is switched from the SWF (work) unit 201a to the SWF (protect) unit 201b in step S710, a determination is then made as to whether the SWF (protect→work) unit 201b has failed or has been removed (step S709), and if the SWF (protect→work) unit 201b has failed or has been removed (step S709: Yes), the TP/data switching unit 354 switches the SWF unit from the SWF (protect→work) unit 201b to a newly provided SWF (protect) unit 201c (step S710).

Next, the FIFO monitor counter 356 is confirmed and a determination is made as to whether there is a FIFO phase shift, that is, a determination is made as to whether there is a phase shift by comparing the received timing of the TP 402 from the SWF (work) unit 201a and the received timing of the TP 402 from the SWF (protect) unit 201c during the initial activation (step S711). The processing from step S712 to S716 are executed hereafter.

In this way, the processing from step S706 to step S716 is repeated during continuous operation every time a SWF unit is switched.

According to the embodiment described above, a packet amount of a buffer (FIFO 355) is monitored at the LIU 202 that receives a timing pulse from the SWF unit 201, and a timing pulse corrected in response to the detected phase shift amount is generated, whereby an increase in the accumulation of shift amounts of the timing pulse caused by repeated switching from the active system SWF unit to the standby system SWF unit, and transmission errors (FIFO slip) of the main signals, can be avoided. Moreover, the provision of a large buffer (multi-stage FIFO) for avoiding main signal transmission errors is made unnecessary.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A transfer apparatus comprising:
a memory;
a first switch configured to:
generate a first timing pulse based on a reference clock;
transmit first information related to the first timing pulse;
a second switch configured to:
generate a second timing pulse based on the reference clock;
transmit second information related to the second timing pulse;
a line interface configured to:
receive signal data and store the signal data in the memory;
transfer the signal data stored in the memory based on the first timing pulse when the first information is received, and transfer the signal data based on the information when the first information is not received and the second information is received;
detect a phase shift between the first timing pulse and the second timing pulse based on the first information and the second information;
transmit the detected phase shift to the second switch; wherein
the second switch is further configured to correct the second timing pulse based on the phase shift.

2. The transfer apparatus according to claim 1, wherein,
the second switch is configured to generate a second timing pulse in accordance with the first timing pulse generated by the first switch.

3. The transfer apparatus according to claim 1, wherein,
when the second timing pulse is delayed more than the first timing pulse by a predetermined clock portion as a result of detecting the phase shift, the second switch corrects the timing generated from the second timing pulse so that the timing generated from the second timing pulse is advanced by the predetermined clock portion.

4. The transfer apparatus according to claim 1, wherein,
when the second timing pulse is advanced more than the first timing pulse by a predetermined clock portion as a result of detecting the phase shift, the second switch corrects the timing generated from the second timing pulse so that the timing generated from the second timing pulse is delayed by the predetermined clock portion.

5. The transfer apparatus according to claims 1, wherein the line interface configured to:
store a received timing of the first information; and
detect the phase shift by comparing the stored received timing with a received timing of the second information.

6. The transfer apparatus according to claims 1, wherein the line interface configured to:
receive a third information from a third switch that had been newly mounted on the transfer apparatus and that generates a third timing pulse based on the reference clock, the third information being related to the third timing pulse;
transfer the signal data based on the third information when the second timing pulse is not received and the third information is received; and
detect a phase shift between the first timing pulse and the third timing pulse based on the second information and the third information; wherein
the third switch is further configured to correct the third timing pulse based on the phase shift.

7. The transfer apparatus according to claim 5, wherein:
when the third timing pulse is delayed more than the first timing pulse by a predetermined clock portion as a result of detecting the phase shift, the third switch corrects the timing generated from the third timing pulse so that the timing generated from the third timing pulse is advanced by the predetermined clock portion.

8. The transfer apparatus to claim 5, wherein:
when the third timing pulse is advanced more than the first timing pulse by a predetermined clock portion as a result of detecting the phase shift, the third switch corrects the timing generated from the third timing pulse so that the timing generated from the third timing pulse is delayed by the predetermined clock portion.

9. The transfer apparatus according to claims 5, wherein the line interface configured to:
store a received timing of the first information and detects the phase shift by comparing the stored received timing with a received timing of the third information.
